(19) United States
(12) Patent Application Publication
(10) Pub. No.: US 2010/0319671 A1
(43) Pub. Date: Dec. 23, 2010

(54) ENGINE-POWERED TOOL

(76) Inventors: Naoto ICHIHASHI, Hitachinaka-shi (JP); Junichi Kamimura, Hitachinaka-shi (JP)

Correspondence Address: MCDERMOTT WILL & EMERY LLP, 600 13TH STREET, N.W., WASHINGTON, DC, 20005-3096, US

(21) Appl. No.: 12/816,037

(22) Filed: Jun. 15, 2010

(30) Foreign Application Priority Data
Jun. 15, 2009 (JP) 2009-142671

(51) Int. Cl. B28D 1/04; B28D 7/00

(52) U.S. Cl. 125/13.01

(57) ABSTRACT

An engine-powered cutter comprising a housing that houses an engine for driving a rotating blade and that is provided to the rear of the rotating blade; an air cleaner chamber provided in the housing to the rear of the engine; a pre-air cleaner chamber provided in the housing on the upstream side of the air cleaner chamber and having an air inflow opening through which air flows in formed in a side wall, an air exhaust opening for exhausting air into the air cleaner chamber formed in a rear partition and a divider wall extending downward beyond the bottom edge of the air exhaust opening from the rear partition above the air exhaust opening between the air inflow opening and the air exhaust opening; and a dust collection chamber provided in the lower side of the pre-air cleaner chamber so as to be free to open and close.

### CROSS-REFERENCE TO RELATED APPLICATION

This application claims the benefit of Japanese Patent Application No. 2009-142671, filed Jun. 15, 2009, the entire disclosure of which is incorporated by reference herein.

### FIELD

This application relates generally to an engine-powered tool such as an engine-powered cutter, and more particularly to an engine-powered tool equipped with a pre-air cleaner chamber upstream of the air cleaner chamber.

### BACKGROUND

When cutting concrete or the like with an engine-powered tool such as an engine-powered cutter, particulates such as concrete powder fly in large quantities around the engine-powered tool. When these flying particulates enter the air filter of the engine tool, the air filter clogs up, reducing engine performance. For that reason, it is necessary for the operator to frequently change or clean the air filter, and this places a large burden on the operator. Hence, the air cleaner noted in the disclosure of Japanese Utility Model Application Publication No. S63-200658 is provided with a general cyclone mechanism upstream of the air filter, so that particulates in the air are removed upstream of the air filter.

At the very minimum, this cyclone mechanism requires an air intake pipe for guiding the air in a direction tangent to the cylindrical part, and an air outflow tube for taking air with few particulates out from the center of the cylindrical part. As a result, the structure becomes complex and the parts numerous, assembly work becomes troublesome and production costs rise.

### SUMMARY

In consideration of the foregoing, it is an objective of the present invention to provide an engine-powered tool that has a simple structure to reduce manufacturing costs, and which can reduce the frequency of air filter maintenance by curtailing clogging of the air filter.

In order to achieve the above objective, the engine-powered tool according to a first aspect of the present invention is provided with:

an engine-powered tool having a rotating blade; a housing that houses an engine for driving the rotating blade and that is provided to the rear of the rotating blade; an air cleaner chamber provided in the housing to the rear of the engine; a pre-air cleaner chamber provided in the housing on the upstream side of the air cleaner chamber and having an air exhaust opening for exhausting air into the air cleaner chamber formed in a side wall and a divider wall extending downward beyond the bottom edge of the air exhaust opening from the side wall above the air exhaust opening between the air inflow opening through which air flows in and the air exhaust opening; and a dust collection unit provided in the lower side of the pre-air cleaner chamber so as to be free to open and close.

In addition, the divider wall preferably extends downward toward the inside of the pre-air cleaner chamber from the side wall in which the air exhaust opening is formed so as to cover the air exhaust opening.

Furthermore, the air exhaust opening is preferably covered by the divider wall and the two sides walls adjacent to the side wall in which the air exhaust opening is formed, so as to open only downward in the pre-air cleaner chamber.

In addition, the junction between the divider wall and the side wall in which the air exhaust opening is formed may be at a position below the bottom edge of the air inflow opening.

Furthermore, the pre-air cleaner chamber is provided in the side of the housing between the engine and the air cleaner chamber in the front-to-back direction of the engine-powered tool, and the air cleaner chamber and the pre-air cleaner chamber may be adjacent to each other, separated by the side wall in which the air exhaust opening is formed.

In addition, the air inflow opening may be formed in one side wall adjacent to the side wall in which the air exhaust opening is formed.

Furthermore, an other side wall adjacent to the side wall in which the air exhaust opening is formed is composed of a side of the housing, and the one side wall adjacent to the side wall in which the air exhaust opening is formed may be provided opposite this other side wall.

In addition the divider wall may be connected to the side wall in which the air exhaust opening is formed, the one side wall and the other side wall; and a screw for fastening a fastener anchoring the dust collection unit in the housing may be formed in the area where the lower edge of the divider wall and the side of the housing connect.

Furthermore, a plurality of air exhaust openings may be provided.

In addition, a plurality of divider walls may be provided so as to respectively correspond to the plurality of air exhaust openings.

Furthermore, the opening and closing part of the dust collection unit may a portion of the housing.

In addition, the air cleaner chamber may constitute a portion of the housing and be provided with an air cleaner cover removably attached to the housing, and the air cleaner cover may be joined together with the opening and closing part of the dust collection unit.

Furthermore, a liquid supply unit capable of supplying liquid to the rotating blade may be provided.

In addition, the dust collection unit may be connected by a fastening member to the housing so as to be capable of opening and closing.

In order to achieve the above objective, the engine-powered tool according to a second aspect of the present invention is provided with:

an engine-powered tool having a rotating blade; a housing that houses an engine for driving the rotating blade and that is provided to the rear of the rotating blade; a handle provided on top of the housing; an air cleaner chamber provided in the housing to the rear of the engine; a pre-air cleaner chamber positioned in the housing and between the engine and the air cleaner chamber and beneath the handle, and having an air inflow opening where air flows in, an air exhaust opening for exhausting air to the air cleaner chamber and side walls that partition the pre-air cleaner chamber; a divider wall provided inside the pre-air cleaner chamber and between the air inflow opening and the air exhaust opening, and which together with the side walls that delineate the air cleaner chamber and the pre-air cleaner chamber forms a passage opening toward the side opposite the handle; and a release unit capable of moving in the housing between a first position constituting one part of the side walls and a second position that releases the outside of the pre-air cleaner chamber to enable the dust accumulated in the pre-air cleaner chamber to be exhausted to the outside.

In order to achieve the above objective, the engine-powered tool according to a third aspect of the present invention is provided with:

an engine-powered tool having a rotating blade; a housing that houses an engine for driving the rotating blade and that is provided to the rear of the rotating blade; a front handle and a rear handled provided on the housing; an air cleaner chamber provided in the housing to the rear of the engine; a pre-air cleaner chamber positioned between the engine and the air cleaner chamber, and having an air inflow opening where air flows in, an air exhaust opening for exhausting air to the air cleaner chamber and side walls that partition the pre-air cleaner chamber; a divider wall provided inside the pre-air cleaner chamber and between the air inflow opening and the air exhaust opening, and which together with the side walls that delineate the air cleaner chamber and the pre-air cleaner chamber forms a passage opening toward the bottom when the tool is held by the front handle and the rear handle; and a release unit capable of moving in the housing between a first position constituting one part of the side walls and a second position that releases the outside of the pre-air cleaner chamber to enable the dust accumulated in the pre-air cleaner chamber to be exhausted to the outside.

With the present invention, particulates are removed from the air upstream of the air filter by a divider wall in the pre-air cleaner chamber of the engine-powered tool, and the removed particulates are confined in a dust collection chamber. Consequently, manufacturing costs are reduced through this simple structure, while the frequency of air filter maintenance can also be reduced by curtailing clogging of the air filter.

### BRIEF DESCRIPTION OF THE DRAWINGS

A more complete understanding of this application can be obtained when the following detailed description is considered in conjunction with the following drawings, in which:

FIG. 1 is a side view of an engine-powered cutter illustrating a first embodiment of the present invention;

FIG. 2 is a top view of a partial cross-section of the engine-powered cutter of FIG. 1;

FIG. 3 is an enlarged side view of a cross-section of the constituent parts of the engine-powered cutter of FIG. 1;

FIG. 4 is a side view of the dust collection chamber of the engine-powered cutter of FIG. 1;

FIG. 5 is a cross-sectional view taken along line V-V in FIG. 4;

FIG. 6 is a cross-sectional view taken along line VI-VI in FIG. 5;

FIG. 7 is a side view of the screw member of the engine-powered cutter of FIG. 1;

FIG. 8 is a frontal view of the screw member of FIG. 7;

FIG. 9 is a cross-sectional view taken along line IX-IX in FIG. 3;

FIG. 10 is a drawing corresponding to FIG. 3 and illustrates another embodiment of the present invention; and

FIG. 11 is a drawing corresponding to FIG. 1 and illustrates still another embodiment of the present invention.

### DETAILED DESCRIPTION

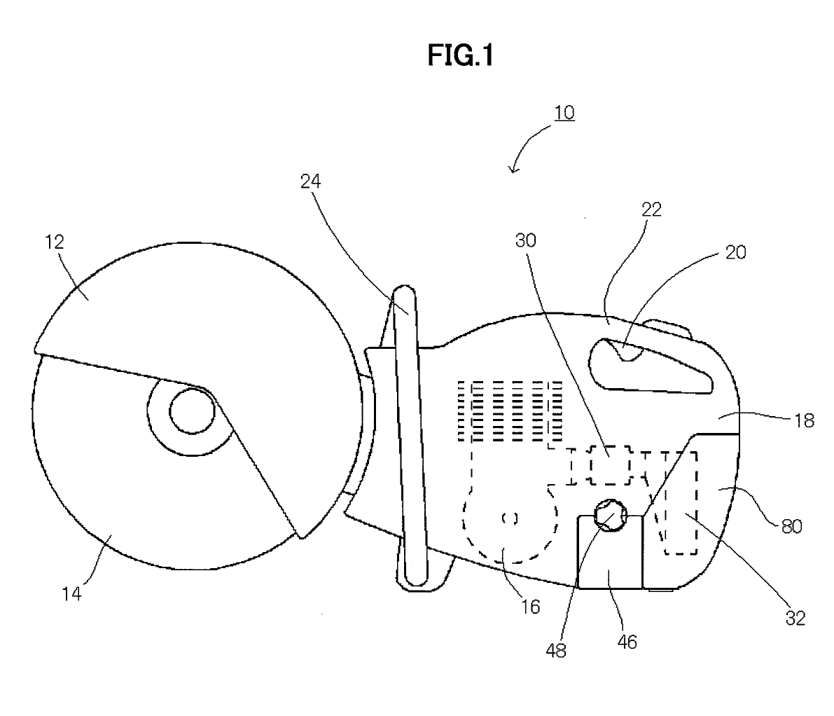

As shown in FIG. 1, an engine-powered cutter 10 (engine-powered tool) according to a first embodiment of the present invention for accomplishing the job of cutting concrete or the like is primarily composed of a rotating blade 14 covered by a protective cover 12, and a housing 18 for housing an engine 16 inside. A rear handle 22 is attached to the top rear of the housing 18. The rear handle 22 is provided with a throttle lever 20 for adjusting the number of revolutions of the engine 16. In addition, a front handle 24 is attached toward the front of the housing 18. Unless stated otherwise, the direction toward the rotating blade 14 from the housing 18 shall be the front of the engine-powered tool, and the opposite direction shall be the rear. That is to say, the left-right directions on the paper in FIG. 1 shall be the front-rear directions. In addition, the up-down directions on the paper in FIG. 1 shall be the up-down directions of the engine-powered tool.

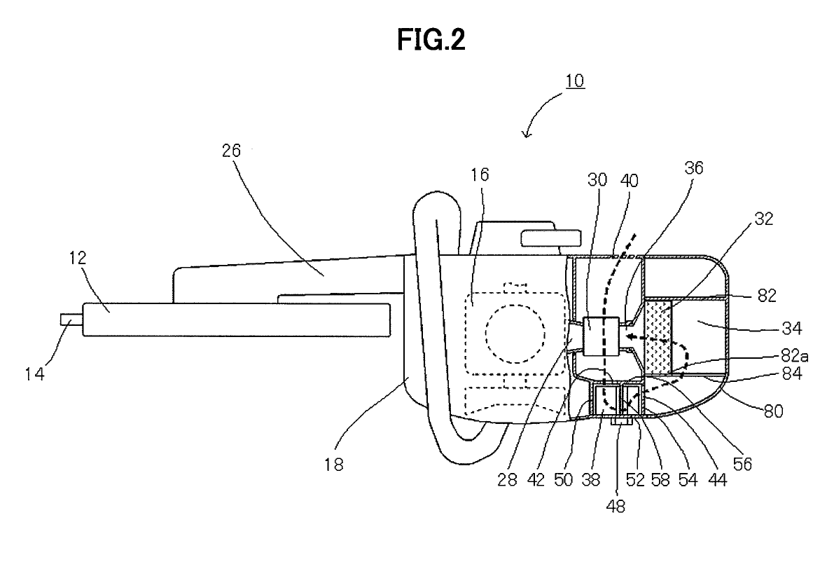

As shown in FIG. 2, a power transfer unit 26 is provided between the housing 18 and the rotating blade 14 covered by the protective cover 12. The power transfer unit 26 is provided inside with unrepresented pulleys and belts, and transfers to the rotating blade 14 power produced by the engine 16.

As shown in FIG. 1 and FIG. 2, a carburetor 30 is connected to the rear of the engine 16 inside the housing 18 via an air intake tube 28. In addition, an air cleaner chamber 34 having an air filter 32 is connected to the rear of the carburetor 30 via a connecting pipe 36. Furthermore, as shown in FIG. 2, a pre-air cleaner chamber 38 is provided between the air cleaner chamber 34 and the engine 16 on one side of the housing 18. In addition, an air intake opening 40 is provided on the other side of the housing 18 from the pre-air cleaner chamber 38. The pre-air cleaner chamber 38 has an air inflow opening 42 opening toward the carburetor 30 on the inside of the housing 18 and an air exhaust opening 44 opening toward the air cleaner chamber 34. In addition, as shown in FIG. 1, a dust collection chamber 46 (dust collection unit) is provided in the lower side of the pre-air cleaner chamber 38 and is removably attached to the housing 18 by a screw member 48 (fastener).

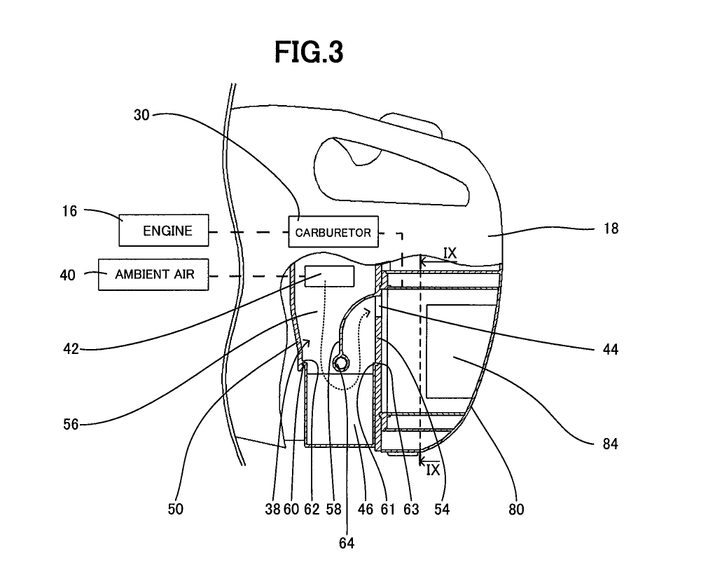

As shown FIG. 2 and FIG. 3, the pre-air cleaner chamber 38 is enclosed by a front partition 50 dividing the chamber from the engine 16, an outside wall 52 comprising the outside wall of the housing 18 (side wall, other side wall), a rear partition 54 dividing the chamber from the air cleaner chamber 34 (side wall, side wall in which the air exhaust opening is formed), an inside wall 56 positioned on the inside of the housing 18 (side wall, other side wall) and an unrepresented ceiling wall. The air inflow opening 42 is formed in the inside wall 56, and the air exhaust opening 44 is formed in the rear partition 54.

As shown in FIG. 3, a divider wall 58 is provided in the pre-air cleaner chamber 38. The divider wall 58 is connected to the top edge of the air exhaust opening 44 in the rear partition 54 and extends downward toward the inside of the pre-air cleaner chamber 38. The bottom edge of the divider wall 58 passes beyond the bottom edge of the air exhaust opening 44 and is positioned at the boundary area with the dust collection chamber 46 in the lower side of the pre-air cleaner chamber 38. Accordingly, in the pre-air cleaner chamber 38, the air exhaust opening 44 is covered by the outside wall 52, the inside wall 56 and the divider wall 58, so that only the bottom of the air exhaust opening 44 is open. That is to say, the divider wall 58 along with the rear partition 54 forms a passage opening to the bottom. Air that has flowed in from the air inflow opening 42 passes through this passage and is guided to the air exhaust opening 44. In addition, the bottom edge of the air inflow opening 42 formed in the inside wall 56 is positioned upward from the connection area of the divider wall 58 with the rear partition 54. Furthermore, on the inside wall 56, the air inflow opening 42 is positioned to the outside of the region enclosed by the divider wall 58 and the rear partition 54.

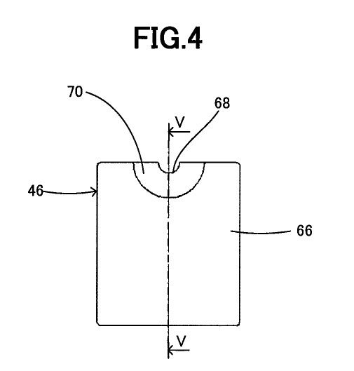

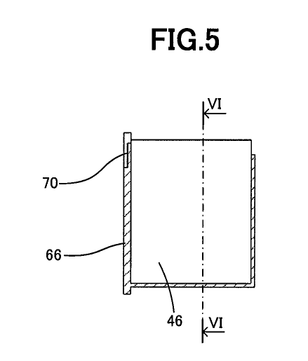

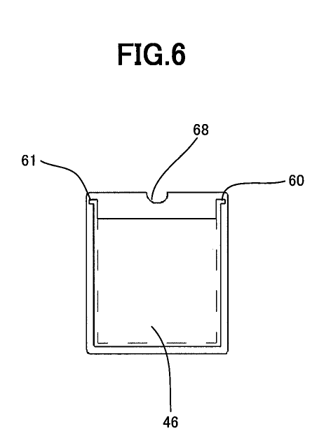

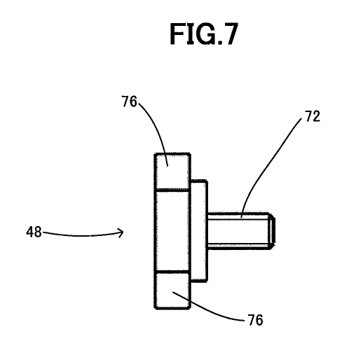

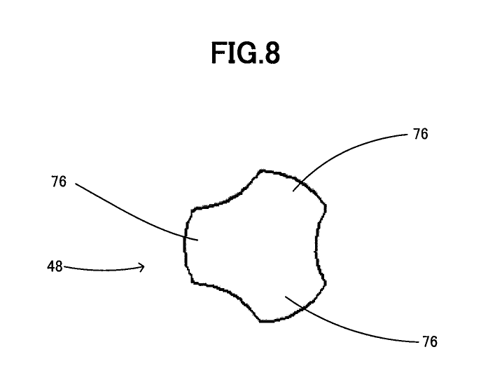

As shown in FIG. 3 and FIG. 6, the dust collection chamber 46 has a front slide 60 and a rear slide 61 on the top edge of the front and rear, respectively (the left and right sides in FIG. 3). In addition, a front rail 62 on which the front slide 60 (left side in the figure) is capable of sliding is formed in the front partition 50. In addition, a rear rail 63 on which the rear slide 61 (right side in the figure) is capable of sliding is formed in the rear partition 54. By inserting the front slide 60 and the rear slide 61 into the front rail 62 and the rear rail 63, the dust collection chamber 46 can be slideably attached to the housing 18 in the lower side of the pre-air cleaner chamber 38. On the other hand, as shown in FIG. 3, a female screw 64 is formed on the bottom edge of the divider wall 58 of the pre-air cleaner chamber 38. In addition, as shown in FIG. 4, FIG. 5 and FIG. 6, a semicircular notch 68 and a seat 70 surrounding this notch 68 are formed on top of the outside surface 66 of the dust collection chamber 46 facing the outside. Furthermore, as shown in FIG. 2, when the dust collection chamber 46 is slid into and inserted in the housing 18, a screw member 48 on which a male screw 72 is formed as shown in FIG. 7 is fastened to the female screw 64 via the notch 68. Through this, the dust collection chamber 46 is anchored to the housing 18 through the seat 70. The dust collection chamber 46 is manufactured from transparent or semi-transparent materials. In addition, as shown in FIG. 8, a holder 76 that protrudes in three places with a spacing of roughly 120 degrees is provided on the screw member 48. In addition, the material of the male screw 72 is metal, as shown in FIG. 7.

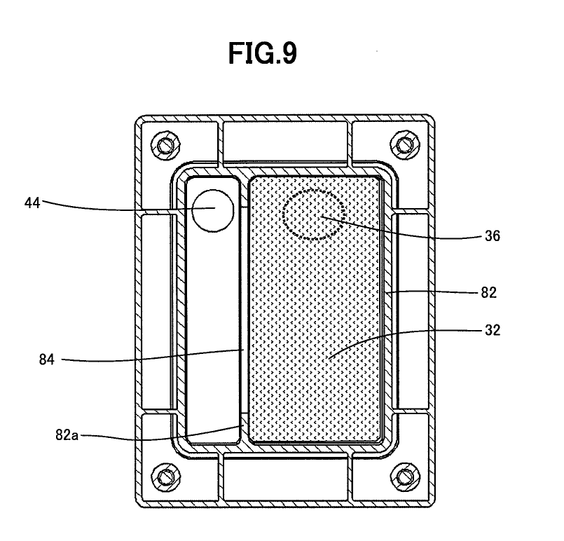

As shown in FIG. 3, the air cleaner chamber 34 is composed of a rear partition 54 and an air cleaner cover 80 that forms part of the outer wall of the housing 18. The air cleaner cover 80 is removably attached by unrepresented bolts or the like to the rear partition 54 of the housing 18. In addition, the air filter 32 is anchored in the air cleaner chamber 34, surrounded by ribs 82, as shown in FIG. 2 and FIG. 9. An opening 84 is formed in the part 82a (bottom side in FIG. 2) positioned on the pre-air cleaner chamber 38 side of the rib 82. As shown in FIG. 9, the air exhaust opening 44 and the connecting pipe 36 are positioned with roughly the same height in the up-and-down direction.

With an engine-powered cutter composed in this manner, air passes through the air intake opening 40 from the outside of the housing 18 and is guided to the inside of the housing 18, as illustrated by the dotted line arrow in FIG. 2. Furthermore, this air flows from the air inflow opening 42 into the pre-air cleaner chamber 38 positioned on the opposite side of the housing 18 from the side on which the air intake opening 40 is provided. Air that has flowed into the pre-air cleaner chamber 38 is directed downward temporarily by the divider wall 58, has its orientation changed to upward by the bottom edge of the divider wall 58 and passes through the air exhaust opening 44 to reach the air cleaner chamber 34, as illustrated by the dotted line arrow in FIG. 3. Following this, the air passes through the air filter 32 and is sent to the carburetor 30. Air with which fuel is mixed in the carburetor 30 is sent to the engine 16.

In this kind of air flow, when the flow of air is temporarily diverted downward by the divider wall 58 provided in the pre-air cleaner chamber 38, some of the particulates with heavy densities relative to the air that are contained in the air drop to the bottom of and accumulate in the dust collection chamber 46 due to their weight. Through this, it is possible to remove some of the particulates in the air from the air, making it possible to reduce the quantity of actual particulates entering the air cleaner chamber 34. Accordingly, with this simple composition that holds down manufacturing costs by providing the divider wall 58 in the pre-air cleaner chamber 38, it is possible to reduce the frequency of maintenance on the air filter 32. In addition, because the lower edge of the divider wall 58 extends beyond the lower edge of the air exhaust opening 44 in the pre-air cleaner chamber 38, the air changes direction from downward to upward at the lower edge of the divider wall 58. Consequently, it is possible to efficiently cause particulates in the air to fall into the dust collection chamber 46, making it possible to further reduce the volume of real particulates entering the air cleaner chamber 34. Moreover, this makes it possible to further reduce the frequency of maintenance on the air filter 32.

Furthermore, the divider wall 58 extends downward so as to cover the air exhaust opening 44, and is enclosed by the outside wall 52 and the inside wall 56 so as to be open only downward. Consequently, only air that has changed direction from downward to upward by the lower edge of the divider wall 58 passes through the air exhaust opening 44. Accordingly, it is possible to efficiently cause particulates in the air to fall into the dust collection chamber 46, making it possible to further reduce the volume of real particulates entering the air cleaner chamber 34. Moreover, this makes it possible to further reduce the frequency of maintenance on the air filter 32.

In addition, the lower edge of the air inflow opening 42 is positioned upward from the junction between the divider wall 58 and the rear partition 54. Consequently, the route followed by air in the downward direction is lengthened, so it is possible to efficiently cause particulates in the air to fall into the dust collection chamber 46, making it possible to further reduce the volume of real particulates entering the air cleaner chamber 34. Moreover, this makes it possible to further reduce the frequency of maintenance on the air filter 32.

Furthermore, the pre-air cleaner chamber 38 and the air cleaner chamber 34 are positioned adjacent to each other, separated by the rear partition 54 in which the air exhaust opening 44 is formed, so it is possible to greatly simplify the structure. Consequently, no additional parts are needed to link the pre-air cleaner chamber 38 and the air cleaner chamber 34, making it possible to reduce costs.

In addition, air guided from the air intake opening 40 flows from the air inflow opening 42 into the pre-air cleaner chamber 38 positioned on the side of the housing 18 opposite the side on which the air intake opening 40 is provided. Consequently, the air can cool the engine 16 and the carburetor 30 when passing through the housing 18.

Furthermore, the dust collection chamber 46 is anchored by the screw member 48 to the engine-powered cutter 10, so the operator, by manipulating the screw member 48 can easily remove the dust collection chamber 46 from the engine-powered cutter 10. Furthermore, the operator, after removing the dust collection chamber 46, can quickly and completely clean out the particulates accumulated in the bottom thereof by simply turning over the bottom surface of the dust collection chamber 46 to face the ground. Consequently, it is possible to further reduce maintenance efforts. Moreover, in the event that the dust collection chamber 46 is damaged, the operator need only change parts, making it possible to reduce the operator's burden.

In addition, the holder 76 is formed on the screw member 48, so it is possible for the operator to rotate the screw member 48 while holding the holder 76. Accordingly, the operator can easily remove the screw member without needing special tools for rotating the screw member 48, greatly improving operability when attaching or detaching the dust collection chamber 46. In addition, the male screw 72 of the screw member 48 is made of metal, so it is possible to significantly increase strength in comparison to using plastic or the like. Furthermore, the dust collection chamber 46 is made of a transparent or semi-transparent material, so the operator can easily see the particulate accumulation status from the outside and can easily tell when it is time to clean the dust collection chamber 46.

In the above embodiment, the divider wall 58 is connected to the inside wall 56 and the outside wall 52 and is also connected near the top edge of the air exhaust opening 44 in the rear partition 54. However, it would also be fine to have a composition in which the divider wall 58 is connected to the inside wall 56, the outside wall 52 and the rear partition 54 above the top edge of the air exhaust opening 44. In addition, it would be fine to have a composition in which the divider wall 58 is connected to the inside wall 56, the outside wall 52 and the ceiling of the pre-air cleaner chamber 38. In these cases as well, the same effects as in the above-described case can be obtained.

In addition, instead of the divider wall 58 being connected to the inside wall 56 and the outside wall 52, separate walls may be formed on the inside of the outside wall 52 (the inside wall 56 side) and the inside of the inside wall 56 (the outside wall 52 side), and for the divider wall 58, the wall on the inside of the outside wall 52 and the wall on the inside of the inside wall 56 to cover the air exhaust opening 44 so that this is only open toward the bottom of the pre-air cleaner chamber 38. In this case as well, the same effects as in the above-described case can be obtained. It would also be fine to form a wall only on the inside of the inside wall 56, or only on the inside of the outside wall 52.

Furthermore, the divider wall 58 (or the walls on the inside of the inside wall 56 and the inside of the outside wall 52 when such walls are formed) may be composed as a separate component and fastened and anchored by an adhesive so as to cover the air exhaust opening 44 in the pre-air cleaner chamber 38. In this case, the same effects as in the above-described case can be obtained, and moreover the structure of the pre-air cleaner chamber 38 becomes simpler, enabling manufacturing costs to be further reduced.

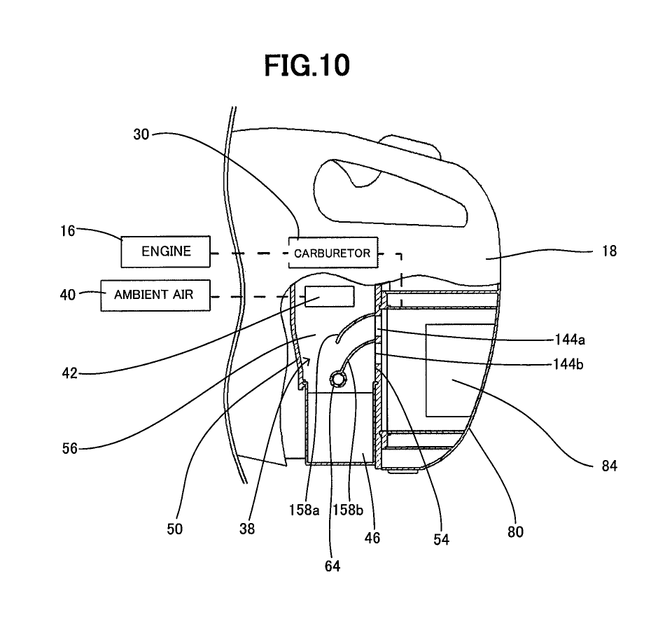

In the above-described embodiment, a single air exhaust opening 44 is formed in the rear partition 54 between the pre-air cleaner chamber 38 and the air cleaner chamber 34, but this is intended to be illustrative and not limiting. For example, as shown in FIG. 10, a first air exhaust opening 144a and a second air exhaust opening 144b may be formed in the rear partition 54. Furthermore, a first divider wall 158a extending toward the bottom of the pre-air cleaner chamber 38 from the top edge of the first air exhaust opening 144a and a second divider wall 158b extending toward the bottom of the pre-air cleaner chamber 38 from the top edge of the second air exhaust opening 144b may be formed on the rear partition 54. With this kind of structure, the diameters of each of the air exhaust openings 144a and 144b can be made smaller, making it possible to send sufficient air into the air cleaner chamber 34 while controlling the influx of particulates. In this case, it would be fine to form a single divider wall for the two air exhaust openings, for example, or to provide divider walls fewer in number than air exhaust openings for a plurality of air exhaust openings.

In addition, in the above-described embodiments the divider wall 58, the first divider wall 158a and the second divider wall 158b are plate-shaped members having roughly arc-shaped cross sections, as shown in FIG. 3 and FIG. 10, but the shapes of these divider walls 58, 158a and 158b are not limited to this shape. For example, the shape of the divider walls 58, 158a, and 158b can be appropriately changed if the shape is open to the bottom and covers the air exhaust opening 44, for example a planar shape, or a box shape or semi-cylindrical shape opening to the bottom.

In addition, in the above-described embodiments the dust collection chamber 46 has a drawer-like structure and can be attached or detached by sliding the chamber relative to the housing 18, but the dust collection chamber 46 is not limited to this structure. For example, the space in the housing 18 in the lower side of the air cleaner chamber 38 could be structured as the dust collection chamber. In this case, a portion of the housing 18 (dust collection chamber) in the lower side of the pre-air cleaner chamber 38 may be structured as a lid member capable of opening and closing by means of a hinge or the like. In addition, this lid member may be structured so as to be attached and detached by means of a screw, a clip or the like. Through this, it is possible to easily remove particulates that accumulate in the dust collection chamber.

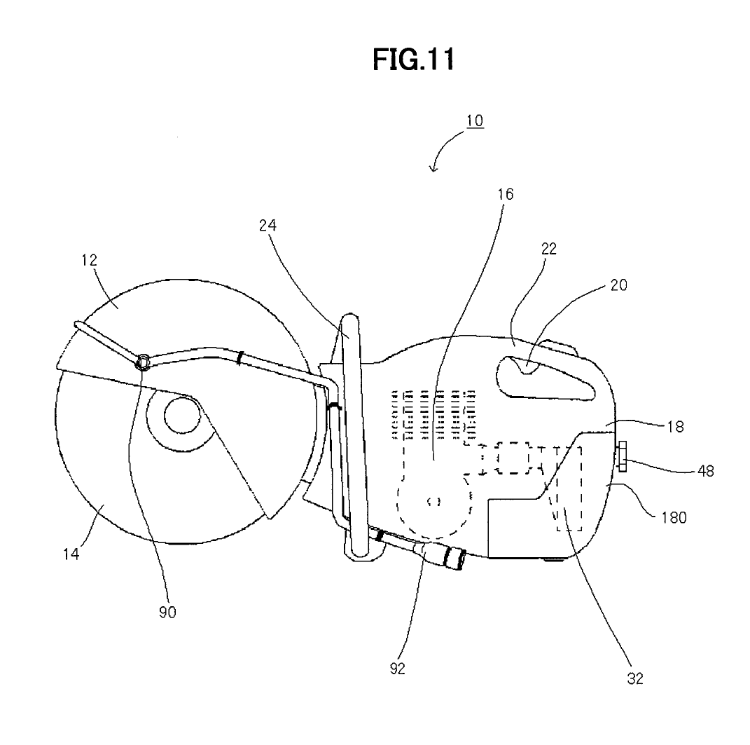

Furthermore, as shown in FIG. 11, the air cleaner cover 180 of the air cleaner chamber 34 may constitute the outside wall of the dust collection chamber 46 extending to the bottom of the pre-air cleaner chamber 38. Furthermore, the air cleaner cover 180 may be removably attached to the housing 18 by means of the screw member 48. In this manner, the air cleaner cover 180 composes the outer wall of the dust collection chamber 46 and the air cleaner chamber 34, and by being removably attached, enables the dust collection chamber 46 and the air filter 32 to be easily cleaned. In addition, by reducing the number of parts, this can curtail manufacturing costs. When the housing 18 in the lower side of the pre-air cleaner chamber 38 or the space formed by the air cleaner cover 180 is used as the dust collection chamber 46, ribs may be appropriately formed on the housing 18 or the air cleaner cover 180 so as to partition the space in the lower side of the pre-air cleaner chamber 38 from other spaces. Through this, particulates can be easily accumulated.

Furthermore, as shown in FIG. 11, the above-described composition may be applied to an engine-powered cutter 10 provided with a water supply pipe 92 connecting to an unrepresented water supply hose for spraying water from a water spray nozzle 90 (liquid supply unit) onto the rotating blade 14. In this case, by accomplishing cutting work while spraying water, damp dust enters the housing. However, this dust is accumulated in the dust collection chamber 46 by the divider wall 58. Furthermore, the collected dust accumulated in the dust collection chamber 46 can be easily removed by removing the dust collection chamber 46, or opening or removing the lid member, or by removing the air cleaner cover 180. Accordingly, it is possible to curb the negative effects of damp dust.

The above-described embodiments were all described for the case wherein the present invention is applied to an engine-powered cutter, but the present invention is not limited to application to an engine-powered cutter but may also be applied to chainsaws, weed whackers or other engine-powered tools.

Having described and illustrated the principles of this application by reference to one (or more) preferred embodiment(s), it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. An engine-powered tool comprising:
a rotating blade;
a housing that houses an engine for driving the rotating blade and that is provided to the rear of the rotating blade;
an air cleaner chamber provided in the housing to the rear of the engine;
a pre-air cleaner chamber provided in the housing on the upstream side of the air cleaner chamber and having an air exhaust opening for exhausting air into the air cleaner chamber formed in a side wall and a divider wall extending downward beyond the bottom edge of the air exhaust opening from the side wall above the air exhaust opening between the air inflow opening through which air flows in and the air exhaust opening; and
a dust collection unit provided in the lower side of the pre-air cleaner chamber so as to be free to open and close.

2. The engine-powered tool according to claim 1, wherein the divider wall extends downward toward the inside of the pre-air cleaner chamber from the side wall in which the air exhaust opening is formed so as to cover the air exhaust opening.

3. The engine-powered tool according to claim 1, wherein the air exhaust opening is covered by the divider wall and the two sides walls adjacent to the side wall in which the air exhaust opening is formed, so as to open only downward in the pre-air cleaner chamber.

4. The engine-powered tool according to claim 1, wherein the junction between the divider wall and the side wall in which the air exhaust opening is formed is at a position below the bottom edge of the air inflow opening.

5. The engine-powered tool according to claim 1, wherein:
the pre-air cleaner chamber is provided in the side of the housing between the engine and the air cleaner chamber in the front-to-back direction of the engine-powered tool; and
the air cleaner chamber and the pre-air cleaner chamber are adjacent to each other, separated by the side wall in which the air exhaust opening is formed.

6. The engine-powered tool according to claim 1, wherein the air inflow opening is formed in one side wall adjacent to the side wall in which the air exhaust opening is formed.

7. The engine-powered tool according to claim 6, wherein:
an other side wall adjacent to the side wall in which the air exhaust opening is formed is composed of a side of the housing; and
the one side wall adjacent to the side wall in which the air exhaust opening is formed is provided opposite this other side wall.

8. The engine-powered tool according to claim 7, wherein:
the divider wall is connected to the side wall in which the air exhaust opening is formed, the one side wall and the other side wall; and
a screw for fastening a fastener anchoring the dust collection unit in the housing is formed in the area where the lower edge of the divider wall and the side of the housing connect.

9. The engine-powered tool according to claim 1, wherein a plurality of air exhaust openings is provided.

10. The engine-powered tool according to claim 9, wherein a plurality of divider walls is provided so as to respectively correspond to the plurality of air exhaust openings.

11. The engine-powered tool according to claim 1, wherein the opening and closing part of the dust collection unit comprises a portion of the housing.

12. The engine-powered tool according to claim 11, wherein:
the air cleaner chamber constitutes a portion of the housing and is provided with an air cleaner cover removably attached to the housing; and
the air cleaner cover is joined together with the opening and closing part of the dust collection unit.

13. The engine-powered tool according to claim 1, further comprising a liquid supply unit capable of supplying liquid to the rotating blade.

14. The engine-powered tool according to claim 1, wherein the dust collection unit is connected by a fastening member to the housing so as to be capable of opening and closing.

15. An engine-powered tool, comprising:
a rotating blade;
a housing that houses an engine for driving the rotating blade and that is provided to the rear of the rotating blade;
a handle provided on top of the housing;
an air cleaner chamber provided in the housing to the rear of the engine;
a pre-air cleaner chamber positioned in the housing and between the engine and the air cleaner chamber and beneath the handle, and having an air inflow opening where air flows in, an air exhaust opening for exhausting air to the air cleaner chamber and side walls that partition the pre-air cleaner chamber;
a divider wall provided inside the pre-air cleaner chamber and between the air inflow opening and the air exhaust opening, and which together with the side walls that delineate the air cleaner chamber and the pre-air cleaner chamber forms a passage opening toward the side opposite the handle; and
a release unit capable of moving in the housing between a first position constituting one part of the side walls and a second position that releases the outside of the pre-air cleaner chamber to enable the dust accumulated in the pre-air cleaner chamber to be exhausted to the outside.

16. An engine-powered tool, comprising:
a rotating blade;
a housing that houses an engine for driving the rotating blade and that is provided to the rear of the rotating blade;
a front handle and a rear handled provided on the housing;
an air cleaner chamber provided in the housing to the rear of the engine;
a pre-air cleaner chamber positioned between the engine and the air cleaner chamber, and having an air inflow opening where air flows in, an air exhaust opening for exhausting air to the air cleaner chamber and side walls that partition the pre-air cleaner chamber;
a divider wall provided inside the pre-air cleaner chamber and between the air inflow opening and the air exhaust opening, and which together with the side walls that delineate the air cleaner chamber and the pre-air cleaner chamber forms a passage opening toward the bottom when the tool is held by the front handle and the rear handle; and
a release unit capable of moving in the housing between a first position constituting one part of the side walls and a second position that releases the outside of the pre-air cleaner chamber to enable the dust accumulated in the pre-air cleaner chamber to be exhausted to the outside.
